(19) United States
(12) Patent Application Publication
(10) Pub. No.: US 2020/0033826 A1
(43) Pub. Date: Jan. 30, 2020

(54) METHOD AND OPERATING UNIT FOR TROUBLESHOOTING ERRORS IN A SYSTEM OF AUTOMATION TECHNOLOGY

(71) Applicant: Endress+Hauser Process Solutions AG, Reinach (CH)

(72) Inventors: Ingomar Sotriffer, Gundelfingen (DE); Michael Mayer, Oberwil (CH); Jan Pflug, Basel (CH); Werner Luber, Allschwil (CH)

(21) Appl. No.: 16/471,038

(22) PCT Filed: Nov. 22, 2017
(86) PCT No.: PCT/EP2017/080045

§ 371 Date: Jun. 19, 2019

(30) Foreign Application Priority Data
Dec. 19, 2016 (DE) 10 2016 124 865.7

(51) Int. Cl. G05B 19/042; G06F 16/29

(52) U.S. Cl. CPC G05B 19/0428; G06F 16/29; G05B 2219/25014; G05B 2219/25187; G05B 2219/24033; G05B 2219/25196; G05B 2219/25062

(57) ABSTRACT

The present disclosure relates to troubleshooting errors in a system of automation technology. For each of a plurality of field devices a current status and location information is stored in a database. The method also includes steps of providing a list of field devices and their location information for which a service status or diagnostic status has been recorded due to an error, and selecting one of the field devices in the list using the operating unit. The method also includes gathering a current location position of an operator using the operating unit, and locating the selected field device using a current location position of the operating unit and the location information of the selected field device using the operating unit. The method also includes connecting the selected field device to the operating unit and operating the selected field device using the operating unit in order to troubleshoot the error.

The invention relates to a method for troubleshooting errors in a system of automation technology, wherein the system has a plurality of field devices which are attached to distributed installation locations. The invention further relates to an operating unit for use in the method according to the invention.

Field devices that are used in industrial facilities are already known from the prior art. Field devices are often used in process automation, as well as in manufacturing automation. Field devices, in general, refer to all devices which are process-oriented and which supply or process process-relevant information. Field devices are thus used for detecting and/or influencing process variables. Measuring devices, or sensors, are used for detecting process variables. These are used, for example, for pressure and temperature measurement, conductivity measurement, flow measurement, pH measurement, fill-level measurement, etc., and detect the corresponding process variables of pressure, temperature, conductivity, pH value, fill-level, flow, etc. Actuators are used for influencing process variables. These are, for example, pumps or valves that can influence the flow of a fluid in a pipe or the fill-level in a tank. In addition to the aforementioned measuring devices and actuators, field devices are also understood to include remote I/O's, radio adapters, or, generally, devices that are arranged at the field level.

A variety of such field devices are produced and marketed by the Endress+Hauser group.

In modern industrial plants, field devices are usually connected to higher-level units via communication networks such as fieldbuses (Profibus®, Foundation® Fieldbus, HART®, etc.). Higher-level units are control units, such as an SPC (storage programmable controller) or a PLC (programmable logic controller). The superordinate units are used for process control as well as for commissioning the field devices, among other things. The measured values detected by the field devices, especially by sensors, are transmitted via the respective bus system to a (or possibly several) superordinate unit(s) that further process the measured values, as appropriate, and relay them to the control station of the installation. The control station serves for process visualization, process monitoring, and process control via the superordinate units. In addition, data transmission from the higher-level unit via the bus system to the field devices is also required, in particular for configuration and parameterization of field devices and for controlling actuators.

Such field devices are usually arranged so as to be distributed over a very wide area in larger systems, in particular in production systems. In the event of an error, or even for routine maintenance, these field devices must be identified and located in the shortest possible time in order to correct the fault on-site or to be able to carry out maintenance. In this instance, precisely locating a field device is usually problematical.

US 2012/0040698 A1 describes an operating unit which has a GPS module. By displaying a map of a process automation system on the display of the operating unit, which map visualizes the current position of the service technician and the location positions of components of the system, a service technician is guided to the various components.

DE 10 2012 108 99 A1 describes several variants by means of which field devices in a process automation system can be located. For example, a service technician sends the identification information of a field device to a database. This then communicates to the service technician at which point in the system the field device is located, so that said service technician is guided with the aid of his operating unit to the installation location of the field device. Alternatively, the service technician submits his current location by means of his operating unit. The database thereupon transmits to the service technician location information of those field devices of the system which are located in a defined vicinity, starting from the location position of the service technician.

In both instances, the field devices to be sought out must be selected manually. For this purpose, which field devices currently have an error must be known to the service technician. Spontaneously occurring errors at field devices are not known to the service technician while he stays in the system.

Proceeding from this problem, the invention is based upon the aim of providing a method and an operating unit that allow faulty field devices of a process automation system to be serviced efficiently and in a time-saving manner.

The aim is achieved by a first variant of a method for troubleshooting errors in a system of automation technology, wherein the system has a plurality of field devices which are attached to distributed installation locations, which method comprises:
accessing a database by means of an operating unit, wherein, for each of the field devices, the current status thereof and location information corresponding to the respective installation location of the field device are stored in the database;
providing a list of those field devices and the location information thereof for which a service status or a diagnosis status has been recorded due to at least one error;
selecting at least one of the field devices in the list by means of the operating unit;
gathering the current location position of an operator by means of the operating unit;
locating the selected field device, including the current location position of the operating unit and the location information of the selected field device, via the operating unit;
finding the located field device by the operator with the aid of the operating unit; and
connecting the operating unit to the sought field device, and operating the field device by means of the operating unit in order to troubleshoot the error.

The great advantage of the first variant of the method according to the invention is that an operator is directed in a targeted manner to field devices exhibiting errors. The operator may select a faulty field device from the list and is guided to this by means of the operating unit. Since the list only gives field devices in which an error is really present, the operator may accomplish the error troubleshooting in an extremely targeted manner.

The operating unit is preferably a mobile operating unit. Such an operating unit has operating elements, e.g., keys, and a screen for displaying the provided list, as well as at least one communication interface for connecting to the field device and to the database. The applicant produces and distributes such an operating unit under the designation, “Field Xpert.” Alternatively, the operating unit is a mobile terminal, in particular a tablet or a smartphone. It may also, alternatively, be a computer unit—for example, a laptop.

The database is, for example, a database which is integrated into a communication network in the control level of the system. The database either independently implements the method step of providing the list, or is connected to a computer unit which accesses the database and subsequently creates and provides the list. It may also be provided that the database be embedded in a cloud environment, wherein the operating unit and/or the computer unit contact the database via the Internet.

The operator is, in particular, a service technician.

Field devices that are mentioned in connection with the method according to the invention are already described by way of example in the introductory part of the description.

Furthermore, the invention is achieved by a second variant of the method for error troubleshooting in a system of automation technology, wherein the system has a plurality of field devices which are attached to distributed installation locations, which method comprises:
creating a list of those field devices for which a service status or a diagnostic status is recorded due to at least one error, as well as location information corresponding to the respective installation locations of the field devices, by means of a database, wherein, for each of the field devices, its current status and the location information are stored in the database,
wherein the database has a radio unit;
searching for radio-contactable operating units by means of the radio unit of the database;
in the event that at least one operating unit has been found, transmitting at least a portion of the list to the operating unit by means of the radio unit;
selecting at least one of the field devices in the list by means of the operating unit;
gathering the current location position of an operator by means of the operating unit;
locating the selected field device, including the current location position of the operating unit and the location information of the selected field device, via the operating unit;
finding the located field device by the operator with the aid of the operating unit; and
connecting the operating unit to the sought field device, and operating the field device by means of the operating unit in order to troubleshoot the error.

The great advantage of the second variant of the method according to the invention is that errors at field devices may be communicated in a simple manner to the service personnel of the system, and may thereby be remedied promptly and effectively. After receiving the list, an operator does not need to first make the affected field devices discoverable, e.g., by means of a system plan, but rather receives the location information, and thus the installation location of the field device, displayed directly with the list, and is guided to this installation location with the aid of the operating unit. In this variant, the database is located in the control system, is connected to a computer unit, and has a radio unit.

Apart from the database, the definitions of the components involved in the method apply analogously to the first variant of the method according to the invention.

According to an advantageous embodiment of the second variant of the method according to the invention, it is provided that the current location positions of the found operating unit be queried by the database, and that the database the list be transmitted to that operating unit whose current location position is closest to at least one of the field devices contained in the list. In the event of an error occurring at a field device, it may in this way be ensured that the faulty field device can be located as quickly as possible by an operator.

According to a preferred embodiment of the first or the second variant of the method according to the invention, it is provided that the field devices listed in the list be prioritized, in particular according to the criticality of the respective field devices for a process of the system and/or according to the severity of the occurred error of one of the field devices. An operator is thereby assisted in planning a route, in that he can estimate the severity of an error. What is understood by the term, “criticality,” is a severity of an error, which severity simultaneously supplies an estimate of the degree of probability that a process might be negatively affected by or come to a standstill due to an error, or that there is a potential hazard.

According to a preferred development of the first or the second variant of the method according to the invention, it is provided that a service path be created in that the at least one operating unit successively locates the field devices according to the order indicated on the list, and wherein the operator locates and operates the field devices according to the created service path. In this instance, the operator is guided in succession to those field devices which have a high priority. Alternatively, however, it may also be provided that the field devices be sorted according to their distance from the current location position of the operator, so that a time-efficient route is created for the operator.

According to an advantageous embodiment of the first or the second variant of the method according to the invention, it is provided that those field devices for which a service status or a diagnostic status is recorded be visualized, together with the current location position of the operating unit, on a map on the operating unit. Particularly in a complex topology of the system, the operator is significantly aided in locating the selected field device.

According to an advantageous embodiment of the first or the second variant of the method according to the invention, it is provided that, during the search for the located field device, the database check whether information or files required to troubleshoot the error are present on the operating unit.

According to a preferred development of the first or the second variant of the method according to the invention, it is provided that, in the event that the information or files needed to troubleshoot the error are not present on the operating unit, these be automatically loaded onto the operating unit. The operator does not need to separately procure this information or these files in a complicated manner; rather, said operator receives these automatically loaded onto the operating unit. In particular, it is provided that this information or these files not only be reviewed during the search for the located field device, but rather also be directly loaded onto the operating unit during the search, so that this information or these files are immediately available to the operator upon arrival at the sought field device.

According to an especially preferred development of the first or the second variant of the method according to the invention, it is provided that the information or files required for troubleshooting the error be loaded from the database onto the operating unit. It is thereby provided that the database itself hold the required information or data. Alternatively, the database sends a network address, in particular an Internet network address or a network address of the communication network of the system, to the operating unit, together with the request that the required information or files be loaded from this network address to the operating unit.

According to an especially preferred development of the first or the second variant of the method according to the invention, it is provided that, as a file required for troubleshooting the error, a device driver or a device description that is required for operating the field device be loaded onto the operating unit.

According to an especially preferred development of the first or the second variant of the method according to the invention, it is provided that, as information required for troubleshooting the error, an operating manual and/or device documentation of the located field device be loaded onto the operating unit. Furthermore, for example, a table with the meaning of occurring error codes may be loaded.

According to a preferred embodiment of the first or the second variant of the method according to the invention, it is provided that information regarding the type of installation of the field device, in particular its installation height and/or its installation inclination or installation angle, be loaded from the database onto the operating unit and displayed to the operator during the location of the located field device. It may also or alternatively be provided that a visualization, in particular a photo, of the field device and/or of the installation location of the field device be loaded and displayed to the operator.

Furthermore, additional information relating to the installation location may also be stored in the database, which information may be loaded onto the operating unit and displayed to the operator. For example, the operator is notified of the instruction that a conductor is needed to reach the field device, or that special protection equipment is required by the operator.

According to an advantageous embodiment of the first or the second variant of the method according to the invention, it is provided that the list be limited to those field devices whose respective installation location is located within a defined vicinity of the current location position of the operating unit.

According to an advantageous embodiment of the first or the second variant of the method according to the invention, it is provided that the database update the current status of the field devices at regular or cyclical time intervals. Furthermore, it may be provided that a field device independently initiate or produce an update to the database in case of the occurrence of an error. For this purpose, the field device sends its current status to the database, or transmits a command to the database that this query the current status of all field devices.

According to a preferred embodiment of the first or second variant of the method according to the invention, it is provided that the operating unit be engaged in a communication connection with the database by means of a radio connection, in particular by means of WLAN, LTE, 5G, or by means of a meshed network.

According to a preferred embodiment of the first or the second variant of the method according to the invention, it is provided that the operating unit be connected to the sought field device by means of a wireless or a wired communication connection.

In the event of a wired communication connection, the operating unit is connected to a service interface, for example. In a field device produced by the applicant, for example, this is a CDI (Common Data Interface) interface. However, the operating unit may also be connected to a USB interface of the field device.

Furthermore, it may be provided that the operating unit be connected to a field bus network, by means of which the field device is engaged in a communication connection with a higher-level unit. After connecting to the fieldbus network, the operating unit represents a participant in the fieldbus and may communicate with the field device via the fieldbus. The fieldbus is, for example, HART, Foundation Fieldbus, CAN-Bus, Modbus, or Profibus PA/DP.

In the event of a wireless communication connection, the operating unit is connected with the field device, in particular via Bluetooth, ZigBee, or WLAN.

Furthermore, the aim is achieved by an operating unit for use in the method according to the invention.

The invention is explained in greater detail with reference to the following figures. The following are shown:

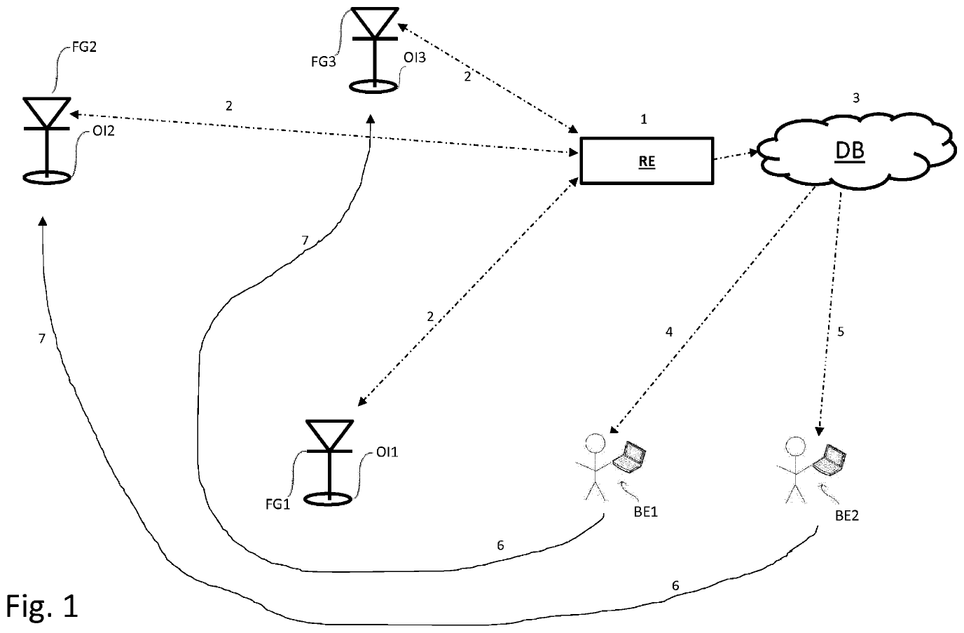

FIG. 1: an exemplary embodiment of the method according to the invention; and

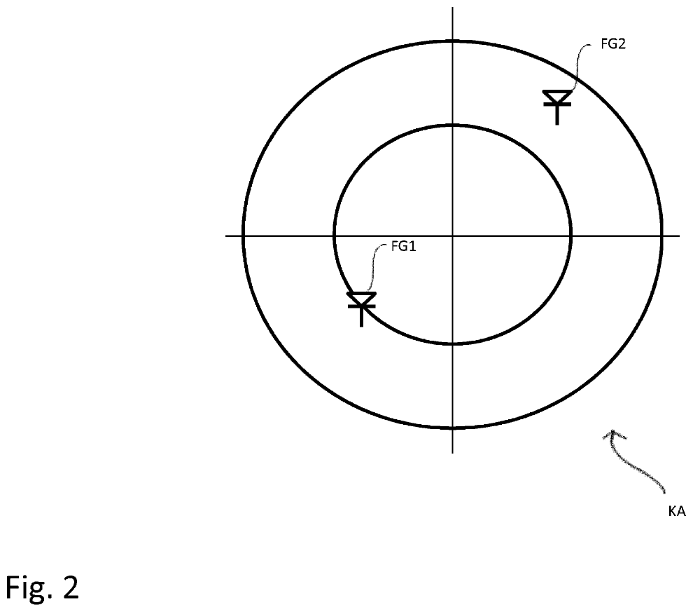

FIG. 2: an example of a map visualized in the display of the operating unit.

FIG. 1 shows an exemplary embodiment of the method according to the invention. In a system of process automation which has the field devices FG1, FG2, FG3, there are two operators with operating units BE1, BE2. These operators are service technicians who remain at the system to service the field devices FG1, FG2, FG3.

In a first method step 1, a computing unit RE queries information from the field devices FG1, FG2, FG3. For example, the querying occurs by means of a radio link, wherein the field devices FG1, FG2, FG3 in this instance have radio antennas and/or radio modules. The computing unit RE is, for example, a workstation PC which is located in the control level of the system. A framework application is installed at the computing unit RE. The framework application is, in particular, an FDT host, which has device drivers in the form of DTM's (device type managers) for each of the field devices FG1, FG2, FG3. The device drivers serve for the communication of the computing unit RE with the field devices FG1, FG2, FG3.

The information to be queried is the status of field devices FG1, FG2, FG3. This information is, in particular, present in a form according to Namur recommendation NE107. Possible statuses are, for example, “Field device in order,” “Error is present,” “Maintenance required,” etc. How often and at what time intervals the querying of the device status is to take place may be set by the system driver in the computing unit RE.

In a second method step 2, the field devices FG1, FG2, FG3 respectively send their current device status to the computing unit. Field device FG1 thereby transmits the status, “Maintenance required”; field device FG2 thereby transmits the status, “Field device in order”; field device FG3 thereby transmits the status, “Error present.” The computing unit RE is linked to a database DB and transmits the read status of the field devices FG1, FG2, FG3 to the database DB.

In a third method step 3, the database DB updates the read status of the field devices FG1, FG2, FG3. In addition, the list contains the location information OI1, OI2, OI3 of the respective field devices, i.e., the geographical position at which the field devices FG1, FG2, FG3 are installed. This location information OI1, OI2, OI3 is, for example, collected upon installation of the field devices FG1, FG2, FG3 in the system and recorded in the database. A list of those field devices FG1, FG2, FG3 whose current status is a service status or a diagnostic status is subsequently created. In this exemplary embodiment, field devices FG1 and field device FG3 are therefore on the list.

This list is subsequently sorted by order of criticality of the respective status, or of the error linked therewith. Since field device FG3 reports a fault, this is to be ranked higher than the pending maintenance requirement of the field device FG1, for which reason field device FG3 is at the first position in the list.

In a fourth method step 4, a portion of the list—more precisely, the highly critical status of field device FG3 that is recorded in the list, and the location information OI3 of the field device FG3—are transmitted from the database DB to an operating unit BE1. For this purpose, the database DB starts a search request by radio for operating units located in the system, and finds the two operating units BE1, BE2. The database DB subsequently queries the current location positions of the operating units BE1, BE2 by means of the radio link. By comparing the location information OI3 of the field device F3 and the current location positions of the operating units BE1, BE2, it is determined that the operating unit BE1 is located closer to the field device FG3 than the operating unit BE2, whereby the status and location information OI3 of field device FG3 are transmitted to said operating unit BE1. After confirmation by the operator that the field device FG3 is to be sought in order to troubleshoot an error, the operating unit BE1 collects its current location position and compares this with the location information of the field device FG3, thus locating the field device FG3. Said operating unit BE1 subsequently graphically depicts the location of the operator and of the field device FG3 on a map KA on its display.

An example of such a map KA is schematically depicted in FIG. 2. Located in the middle is the current location position of the operating unit BE1, BE2. The circles indicate a defined length—for example, 100 meters. If the operator moves, the center position of the map KA is thus displaced. Such a map KA is described in US 2012/0040698 A1, for example.

In a fifth method step 5, the less critical status of the field device FG1 that is recorded in the list is transmitted to the operating unit BE2. This is either automatically accepted from the database DB, analogously to method step 4, or the operator of the operating unit BE2 himself loads the list from the database DB onto the operating unit BE1. The operator subsequently selects the field device FG1 from the list, as a result of which the field device FG1 is located, analogously to method step 4.

In a sixth method step 6, the respective operator of the operating units BE1, BE2 is guided by means of the displayed map KA to the respective located field devices FG1, FG3. For this purpose, a GPS module of the operating units BE1, BE2, for example, is used. However, other methods may also be used for navigation, such as locating by means of radio signal strengths (field device FG1, FG2, FG3 relative to operating unit), or triangulation via a mobile communications network.

While the operators move to the located field devices FG1, FG2, the database checks whether all the information or files required to troubleshoot the respective error of the field device FG3, or to successfully service the field device FG1, are present on the operating units BE1, BE2. Operating units BE1, BE2 require the respective correct device driver of the field device FG1, FG3 in order that, for example, said operating units BE1, BE2 may communicate with the respective field devices FG1, FG3. In the event that this information is not present on the operating units BE1, BE2, the database DB transmits this to the operating units BE1, BE2, respectively. The checking and transmission is repeated for further information or files which are useful for the operator, in particular the device documentation, the installation height of the field device, a photo of the installation site, etc. In particular, it is provided that all relevant information be present on the operating units BE1, BE2 upon arrival of the operators at the respective field devices FG1, FG3.

In a final, seventh method step 7, when the operators encounter the respective field devices FG1, FG3, the information is displayed to the user or the files are loaded, ready to be executed, on the respective operating units BE. By means of the information, the operator may connect the respective operating unit BE1, BE2 to the corresponding field device FG1, FG3 as quickly as possible, in particular wired or wirelessly. For example, a step-by-step instruction which guides the user through the process of connecting has also been loaded. After connecting, a communication unit is established by means of the execution-ready device driver between the respective operating unit BE1, BE2 and the corresponding field device FG1, FG3. The operator may now operate the corresponding field devices FG1, FG3 in a simple manner and perform maintenance, or troubleshoot the error at the field device FG3. Analogously to method step 6, additional information that is loaded on the operating unit BE1, BE3, e.g., a table with the meaning of error codes, may also be displayed for this purpose.

It is inherently understood that the method according to the invention may be used with any type of field device. Field devices that are mentioned in connection with this method according to the invention are already described by way of example in the introductory part of the description. Furthermore, it may be provided that the database DB also automatically transmit portions of the list with field devices having less critical maintenance status to operating units BE1, BE2, or that portions of the list with highly critical statuses of field devices also be loaded manually by the operating units BE1, BE2 from the database. Furthermore, the entire list may also be transmitted to the operating units BE1, BE2, and the operator manually selects one of the field devices FG1, FG3 found on the list.

### LIST OF REFERENCE SYMBOLS

1, 2, 3, 4, 5, 6, 7 Method steps
BE Operating unit
DB Database
FG1, FG2, FG3 Field device
KA Map
OI1, OI2, OI3 Location information of the field devices
RE Computing unit

1-17. (canceled)

18. A method for troubleshooting errors in a system of automation technology, wherein the system has a plurality of field devices which are attached at distributed installation locations, the method comprising steps of:
accessing a database using an operating unit, wherein for each of the field devices a current status and location information corresponding to the respective installation location of the field device are stored in the database;
providing a list of field devices and respective location information for which a service status or a diagnostic status has been recorded due to at least one error;
selecting at least one of the field devices in the list using the operating unit;
gathering a current location position of an operator using the operating unit;
locating the selected field device, including the current location position of the operating unit and the location information of the selected field device, via the operating unit;
finding the selected field device by the operator with the aid of the operating unit; and
connecting the operating unit to the selected field device, and operating the selected field device by means of the operating unit in order to troubleshoot the error.

19. A method for troubleshooting errors in a system of automation technology, wherein the system has a plurality of field devices which are attached at distributed installation locations, the method comprising steps of:
creating a list of the field devices for which a service status or a diagnostic status is recorded due to at least one error, and location information corresponding to respective installation locations of the field devices, using a database, wherein, for each of the field devices, a current status and the respective location information is stored in the database, wherein the database has a radio unit;
searching for radio-contactable operating units by means of the radio unit of the database;
if at least one operating unit has been found, transmitting at least a portion of the list to the operating unit using the radio unit;
selecting at least one of the field devices in the list using the operating unit;
determining a current location position of an operator using the operating unit;
locating the selected field device, including a current location position of the operating unit and the location information of the selected field device, via the operating unit;
finding the selected field device by the operator using the operating unit; and
connecting the operating unit to the selected field device, and operating the selected field device by means of the operating unit in order to troubleshoot the error.

20. The method of claim 18, wherein the database queries current location positions of the found operating units, and wherein the list is transmitted to the operating unit whose current location position is closest to at least one of the field devices contained in the list.

21. The method of claim 18, wherein the field devices are prioritized in the list according to criticality of the respective field device for a process of the system and/or according to a severity of the error of the respective field device.

22. The method of claim 21, wherein a service path is created by the operating unit successively locating field devices according to an order of the prioritized list, and wherein the operator operates the field devices according to the service path.

23. The method of claim 18, wherein the field devices for which the service status or the diagnostic status is recorded are visualized, together with the current location position of the operating unit, on a map on the operating unit.

24. The method of claim 18, wherein, while searching for the selected field device, the database checks whether information for troubleshooting the error is present on the operating unit.

25. The method of claim 24, wherein, if the information for troubleshooting the error is not present on the operating unit, the information is automatically loaded onto the operating unit.

26. The method of claim 25, wherein the information for troubleshooting the error is loaded from the database onto the operating unit.

27. The method of claim 25, wherein a device driver or a device description for operating the selected field device is loaded onto the operating unit as a file for troubleshooting the error.

28. The method of claim 25, wherein an operating manual or a device documentation for the selected field device are loaded onto the operating unit as a file for troubleshooting the error.

29. The method of claim 18, wherein, while searching for the selected field device, information regarding a type of installation of the selected field device is loaded from the database onto the operating unit and is displayed to the operator.

30. The method of claim 18, wherein the list is restricted to field devices whose respective location information indicates a location within a defined vicinity of the current location position of the operating unit.

31. The method of claim 18, wherein the database updates the current status of each of the field devices at regular time intervals.

32. The method of claim 18, wherein the operating unit has a communication connection with the database via a radio link.

33. The method of claim 18, wherein the operating unit is connected to the selected field device via a wireless or a wired communication connection.

34. An operating unit for troubleshooting errors in a system of automation technology, wherein the system has a plurality of field devices which are attached at the distributed installation locations, comprising:
a communication connection with a database via a radio link;
wherein the database stores a current status and location information corresponding to the respective installation location of the field device;
a list of field devices and respective location information for which a service status or a diagnostic status has been recorded due to at least one error;
wherein the operating unit selects at least one of the field devices in the list, gathers a current location position of an operator using the operator unit, locates the selected field device, including the current location position of the operating unit and the location information of the selected field device, and assists the operator in finding the selected field device; and
wherein the operating unit is connected to the selected field device and operates the selected field device in order to troubleshoot the error.
